(19) United States
(12) Patent Application Publication
(10) Pub. No.: US 2015/0135522 A1
(43) Pub. Date: May 21, 2015

(54) METHOD FOR PRODUCING BATTERY PACK

(71) Applicant: SANYO Electric Co., Ltd., Osaka (JP)

(72) Inventors: Takashi Seto, Hyogo (JP); Eiji Okutani, Hyogo (JP); Kazuhiro Fujii, Hyogo (JP)

(73) Assignee: Sanyo Electric Co., Ltd., Osaka (JP)

(21) Appl. No.: 14/400,555

(22) PCT Filed: Jul. 31, 2013
(86) PCT No.: PCT/JP2013/004631

§ 371 Date: Nov. 12, 2014

(30) Foreign Application Priority Data
Aug. 9, 2012 (JP) 2012-176712

(51) Int. Cl. H01M 2/36

(52) U.S. Cl. CPC H01M 2/365
USPC 29/623.2

(57) ABSTRACT

A method for manufacturing a battery pack comprises a compressing step of stacking a plurality of flat secondary batteries, compressing and fixing in a pressed state of the flat secondary batteries constituting the battery staked member by applying a predetermined pressure in the stacking direction. Further, in the pressed shaping step, a pressing pressure of pressing the spiral electrode assembly is set, such that it is possible to insert the pressed electrode assembly into the outer can, and such that it is possible that the electrode assembly is swollen until the electrode assembly presses against the inner surface of the outer can when the electrode assemblies are swollen by the electrolyte injected into the outer can in the electrolyte injection step, and in the compressing step, the swollen electrode assemblies are pressed through the outer cans by pressing the outer cans of the flat secondary batteries.

### CROSS-REFERENCE TO RELATED APPLICATIONS

The present application is a national stage application of international application PCT/JP2013/004631 filed on Jul. 31, 2013, and claims the benefit of foreign priority of Japanese patent application 2012-176712 filed on Aug. 9, 2012, the contents both of which are incorporated herein by reference.

### TECHNICAL FIELD

The present invention is related to a method for manufacturing a battery pack in which a plurality of flat secondary batteries are stacked, especially, a method for manufacturing a battery pack in which the flat secondary batteries are fixed in a the pressed state, while an electrolyte is smoothly injected.

### BACKGROUND ART

A flat secondary battery in which an electrode assembly and an electrolyte as elements of generation of electricity are sealed in an outer case having a rectangular box shape, is developed (refer to patent literature 1).

In the flat secondary battery, the electrode assembly is swollen by charging and discharging. Concretely, the electrode assembly is swollen by charging the flat secondary battery, and is contracted by discharging the flat secondary battery. Further, active layers of the electrode assembly are swollen also by repeatedly charging and discharging. Since by the swell of the electrode assembly, a distance between positive and negative electrode plates is increased, there is a problem that battery characteristics are degraded.

As the power source having a high output or a high capacity in which this type of the secondary battery is used, a battery pack in which a plurality of the flat secondary batteries are stacked, is developed (refer to patent literature 2).

In this battery pack, a volume efficiency is high, and an energy density to volume is high. Concretely, by connecting the stacked flat secondary battery in series, the output voltage is increased, and by connecting the stacked flat secondary battery in parallel, the capacity is increased. In this battery pack, a plurality of the flat secondary batteries are stacked through insulating member as the battery staked member, and end plates are disposed at both ends of the battery staked member, and the end plates are coupled by binding bars, and the flat secondary batteries are fixed in the stacked state.

### CITATION LIST

### Patent Literature

### Patent Literature 1:

Japanese Laid-Open Patent Publication No. 2010-287530

### Patent Literature 2:

Japanese Laid-Open Patent Publication No. 2011-23301

### SUMMARY OF THE INVENTION

In the flat secondary battery of patent literature 1, a swell of an electrode assembly is suppressed or reduced by enlarging press pressure in a pressed shaping step of pressing a spiral electrode assembly into a flat spiral electrode assembly. It is the reason why the spiral electrode assembly is pressed by a large pressure, a positive electrode plate, a negative electrode plate, and a separator become in a tightly contacted or consolidated state.

However, when the flat spiral electrode assembly in the tightly contacted or consolidated state, is inserted into a flat outer case, and an electrolyte is injected into the outer case, there is a demerit that it takes a long time. It is the reason why it is difficult that the electrolyte infiltrates minute vacancies between the positive electrode plate, the negative electrode plate, and the separator. A long time in the electrolyte injection makes cycle time in a manufacturing process longer, and manufacturing efficiency lower, and manufacturing cost higher.

The present disclosure is developed for the purpose of solving such drawbacks. One non-limiting and explanatory embodiment provides a method for manufacturing a battery pack which prevents a decline in electric properties caused by swell of an electrode assembly, while an electrolyte is quickly injected into the outer case.

A method for manufacturing a battery pack of the present disclosure comprises a winding step of winding into a spiral electrode assembly a positive electrode plate and a negative electrode plate interposing separators therebetween, a pressed shaping step of pressing the spiral electrode assembly obtained in the winding step into an electrode assembly of a flat shape, an electrolyte injection step of inserting the electrode assembly of the flat shape obtained in the pressed shaping step into an outer can of a flat shape, and injecting an electrolyte into the outer can, a sealing step of airtightly sealing the outer can in which the electrolyte is injected, and a compressing step of stacking a plurality of flat secondary batteries obtained in the sealing step as a battery staked member, compressing and fixing in a pressed state of the flat secondary batteries constituting the battery staked member by applying a predetermined pressure in the stacking direction of the battery staked member. Further, in the pressed shaping step, a pressing pressure of pressing the spiral electrode assembly is set, such that it is possible to insert the pressed electrode assembly into the outer can, and such that it is possible that the electrode assembly is swollen until the electrode assembly presses against the inner surface of the outer can when the electrode assemblies are swollen by the electrolyte injected into the outer can in the electrolyte injection step, and in the compressing step, the swollen electrode assemblies are pressed through the outer cans by pressing the outer cans of the flat secondary batteries.

Accordingly, in the method for manufacturing the battery pack, it prevents a decline in electric properties caused by swell of the electrode assembly, while the electrolyte is quickly injected into the outer can of the flat secondary battery. Thus, the electrolyte is quickly injected into the outer case. That is the reason why the pressing pressure of pressing the spiral electrode assembly is set at a low pressure such that it is possible that the electrode assembly is swollen until the electrode assembly presses against the inner surface of the outer can when the electrode assemblies are swollen by the electrolyte injected into the outer can in the electrolyte injection step. The electrode assembly swollen by the electrolyte can make the electrolyte injected under a pressurized condition quickly infiltrate between the positive electrode plate and the negative electrode plate. Here, as the electrode assembly tends to be swollen by charging and discharging, in the compressing step, the swollen electrode assemblies are pressed through the outer cans by pressing the outer cans of the flat secondary batteries. As the flat secondary batteries are compressed, fixed, and held in a pressed state, the swell of the electrode assembly is suppressed or reduced, and then it prevents the decline in electric properties caused by the swell of the electrode assembly

The method for manufacturing the battery pack of the present disclosure, the pressing pressure in the pressed shaping step can be lower than the pressure in the compressing step.

Accordingly, as the pressing pressure of the spiral electrode assembly in the pressed shaping step is lower than the pressure of the flat secondary battery in the compressing step, the electrode assembly in the pressed shaping step does not become in a tightly contacted or consolidated state of high density, and then the electrolyte in the electrolyte injection can quickly infiltrate into the electrode assembly.

The method for manufacturing the battery pack of the present disclosure, the flat secondary battery incorporates a current interrupt device which interrupts current by an increase of an internal pressure, and in the electrolyte injection step, the electrolyte is injected under a pressurized condition by a lower pressure than a working pressure of interrupting current in the current interrupt device.

Accordingly, without the current interrupt device working, the electrolyte can quickly infiltrate into the electrode assembly.

The method for manufacturing the battery pack of the present disclosure, in the electrolyte injection step, while the pressure of the outer can is reduced, the electrolyte is injected under the pressurized condition.

Accordingly, the electrolyte in the electrolyte injection can quickly infiltrate into the electrode assembly. That is the reason why the electrode assembly of which spaces, gaps, voids, or the like is under the reduced pressure by reducing the pressure inside the outer can, is infiltrated by the pressurized electrolyte.

The method for manufacturing the battery pack of the present disclosure, in the electrolyte injection step, the electrolyte is injected by repeating a step of reducing the pressure of the inside of the outer can, and a step of injecting the electrolyte under the pressurized condition.

Accordingly, in the electrolyte injection step, the electrolyte can quickly infiltrate into the electrode assembly. Further, as the electrolyte can quickly infiltrate into the electrode assembly, in the electrolyte injection step, the pressurized pressure under which the electrolyte is injected can be made lower. Therefore, without the current interrupt device working, the electrolyte can quickly be injected.

The method for manufacturing the battery pack of the present disclosure, in the step before the electrolyte injection step, a sealing plate having an injection hole is fixed to an opening portion of the outer can, and in the electrolyte injection step, the electrolyte is injected through the injection hole, and in the compressing step, the injection hole is airtightly sealed.

Accordingly, as the electrolyte is injected through the injection hole, the electrolyte under the pressurized condition can be injected, and then its structure is simple, and the injection hole can be easily airtightly sealed.

The method for manufacturing the battery pack of the present disclosure, in the compressing step, end plates are disposed at both ends of the battery staked member, and by binding bars being coupled to the end plates, the flat secondary batteries of the battery staked member are compressed and fixed in the pressed state.

Accordingly, in the state that the binding bars are coupled to the end plates, the compressing pressure is controlled and set at an optimum value, and the flat secondary battery can be compressed and fixed in the pressed state.

### BRIEF DESCRIPTION OF DRAWINGS

FIG. 1 is a perspective view of a battery pack related to an embodiment of the present disclosure.

FIG. 2 is an explored perspective view of the battery pack shown in FIG. 1.

FIG. 3 is a schematic sectional view showing a state of pressing a battery staked member from both sides.

FIG. 4 is an explored perspective view showing a manufacturing step of an electrode assembly 11.

FIG. 5 is a schematic sectional view showing a manufacturing step of the electrode assembly 11.

FIG. 6 is a perspective view showing a manufacturing step of the electrode assembly 11.

FIG. 7 is an explored perspective view showing a manufacturing step of a flat secondary battery 1.

FIG. 8 is a front view of the flat secondary battery 1.

FIG. 9 is a schematic vertical longitudinal sectional view showing an internal structure of the flat secondary battery 1.

FIG. 10 is a schematic vertical lateral sectional view showing an internal structure of the flat secondary battery.

FIG. 11 is a schematic structure view showing one example of the electrolyte injection apparatus

FIG. 12 is a front view of an insulating member.

FIG. 13 is a vertical sectional view showing a stacked structure of the flat secondary batteries and insulating members.

FIG. 14 is an explored sectional view of the flat secondary battery and the insulating members shown in FIG. 13.

FIG. 15 is a horizontal sectional view showing a stacked structure of the flat secondary batteries and the insulating member.

### DESCRIPTION OF EMBODIMENTS

Hereinafter, the embodiment of the present invention will be described referring to drawings. However, the following embodiments illustrate a method for manufacturing a battery pack which is aimed at embodying the technological concept of the present invention, and the present invention is not limited to the method for manufacturing the battery pack described below. However, the members illustrated in Claims are not limited to the members in the embodiments.

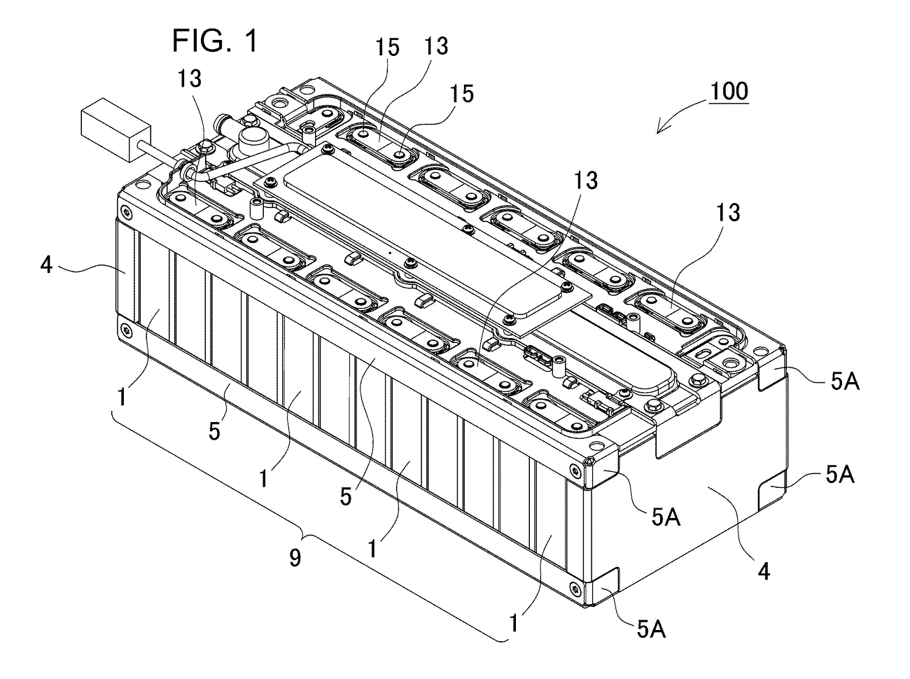

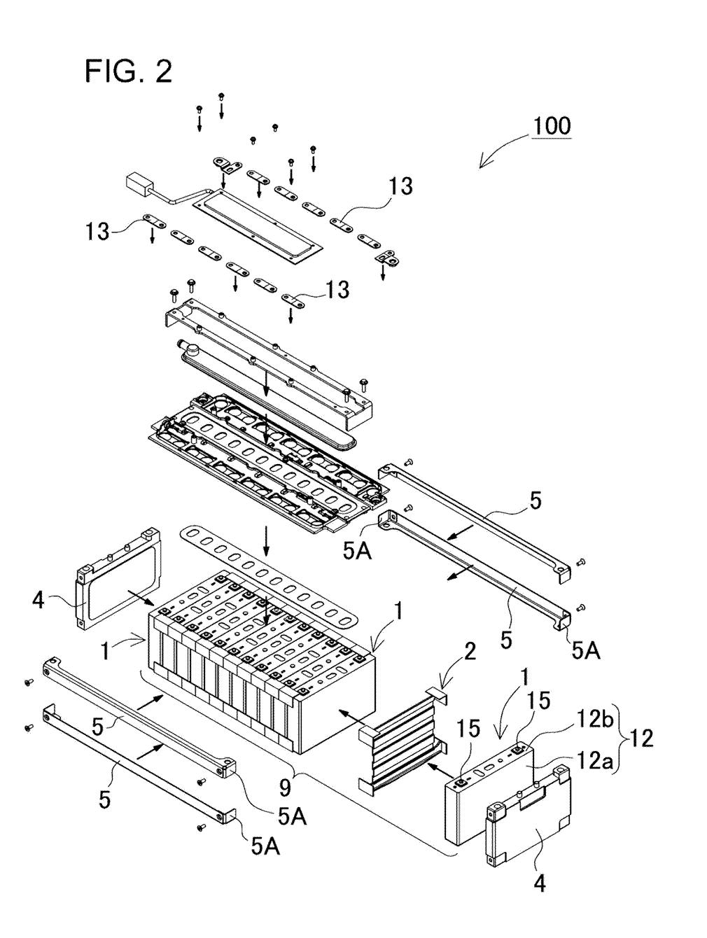

A battery pack 100 of FIG. 1 to FIG. 3 comprises a battery stacked member 9 in which flat secondary batteries 1 and insulating members 2 are alternately stacked, end plates 4 which are disposed at both ends of the battery staked member 9 in the stacked direction, and binding bars 5 coupling the end plates by which the flat secondary batteries 1 of the battery staked member 9 are compressed and fixed in the pressed state in a predetermined compressed pressure.

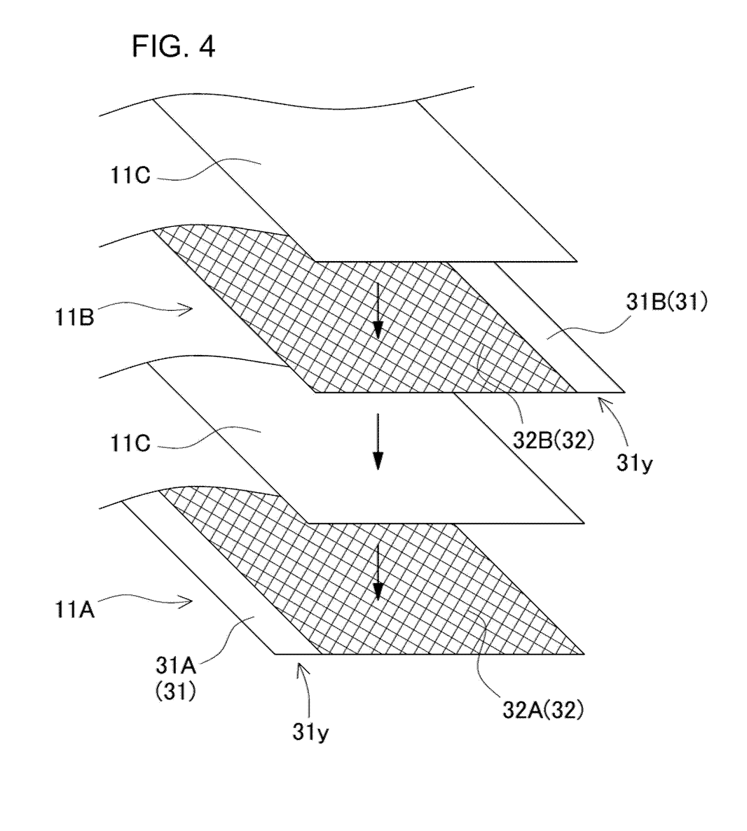

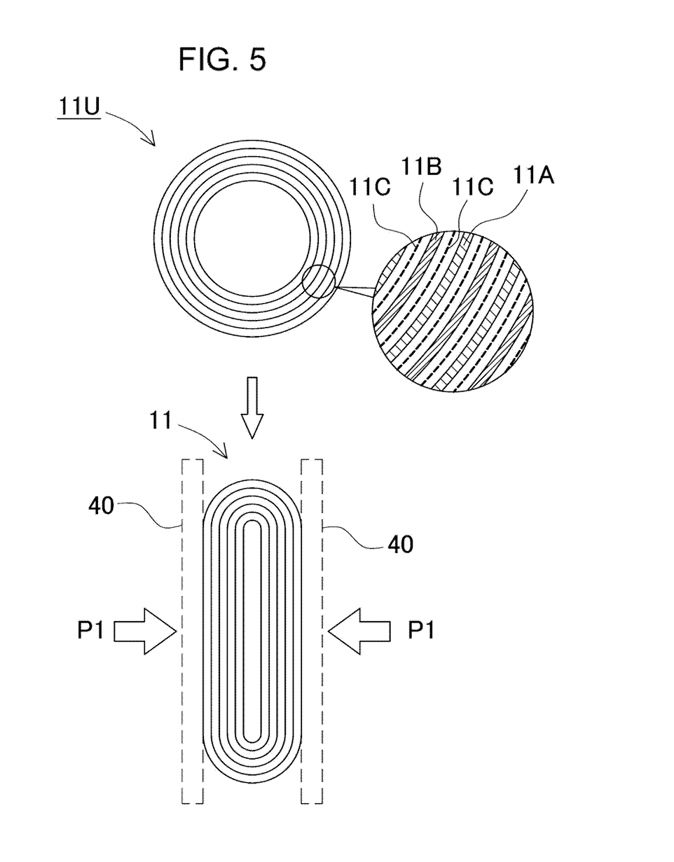

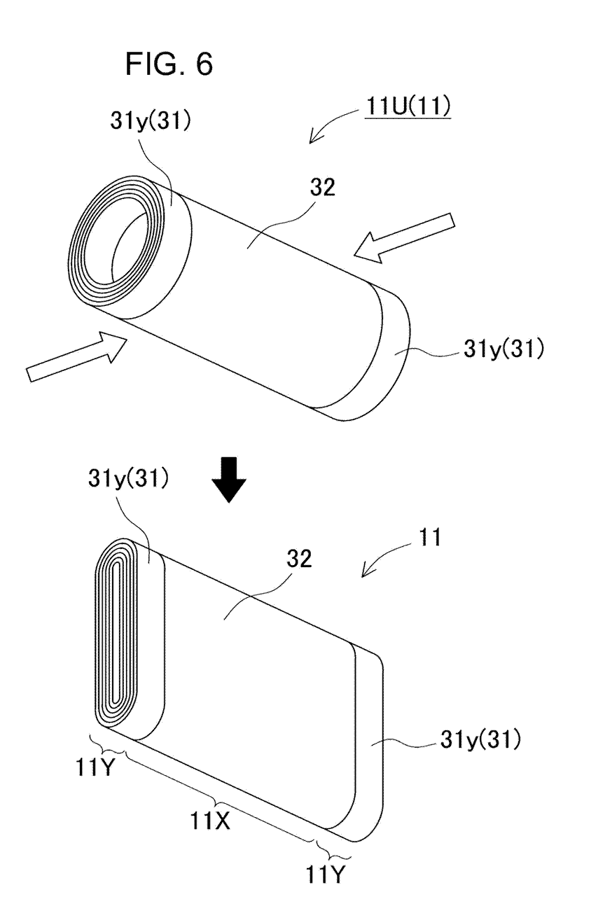

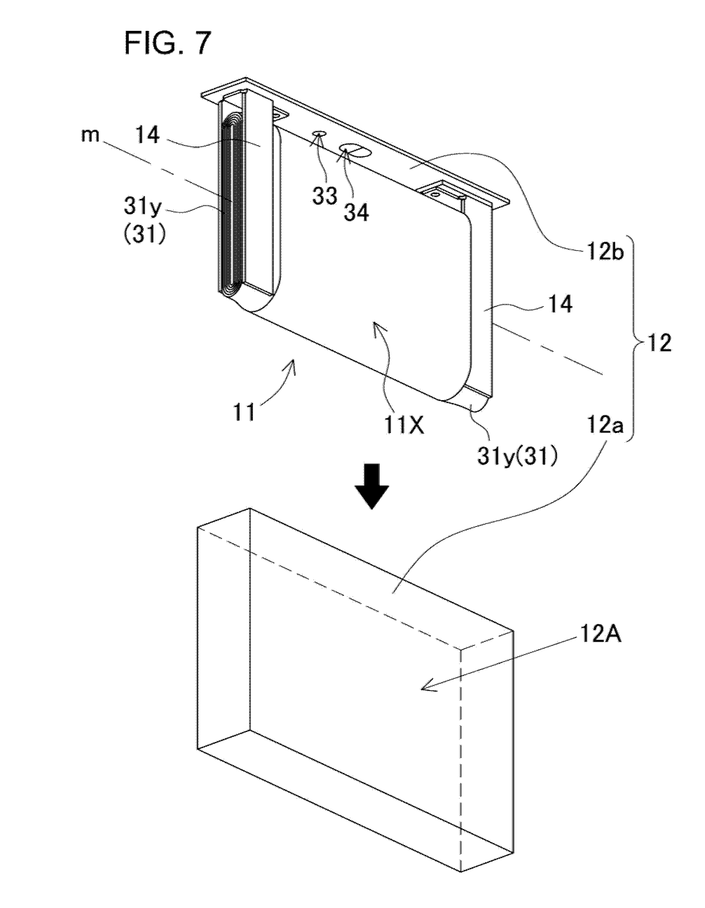

The flat secondary battery 1 is manufactured in the following way. As shown in FIG. 4, a positive plate 11A and a negative plate 11B are stacked interposing separators 11C therebetween, and this is wound as shown in FIG. 5 and FIG. 6, and a spiral electrode assembly 11U is made (winding step). This spiral electrode assembly 11U is pressed into an electrode assembly 11 of a flat shape under a predetermined pressing pressure (pressed shaping step). As shown in FIG. 7, the electrode assembly 11 of the flat shape is inserted into an outer can 12a of a flat shape, and an electrolyte is injected into the outer can 12a (electrolyte injection step). The outer can 12a in which the electrolyte is injected is airtightly sealed (sealing step).

The mixture of an active material 32, a conductive agent, and a binder is formed on the surfaces of a core 31, and the positive plate 11A and the negative plate 11B are made. After a sealing plate 12b is weld-fixed to an opening portion of the outer can 12a, the electrolyte is injected into the outer can 12a through an injection hole 33 of the sealing plate 12a. After the injection of the electrolyte, the injection hole 33 is airtightly closed. Here, after the injection of the electrolyte, in the flat secondary battery 1, the opening portion of the outer can 12a can be closed by the sealing plate 12.

The non-aqueous electrolyte battery is suitable for the flat secondary battery 1. A lithium ion secondary battery is suitable for the non-aqueous electrolyte battery. The battery pack in which the flat secondary battery 1 is the lithium ion secondary battery of the non-aqueous electrolyte battery can increase a charging capacity with respect to volume and weight of the battery staked member 9. In the present invention, the flat secondary battery is not specified by the lithium ion battery of the non-aqueous electrolyte battery, and all rechargeable batteries, for example, such as, the non-aqueous electrolyte battery other than the lithium ion battery, a nickel hydride battery, a nickel cadmium battery, or the like can be applied to the present invention.

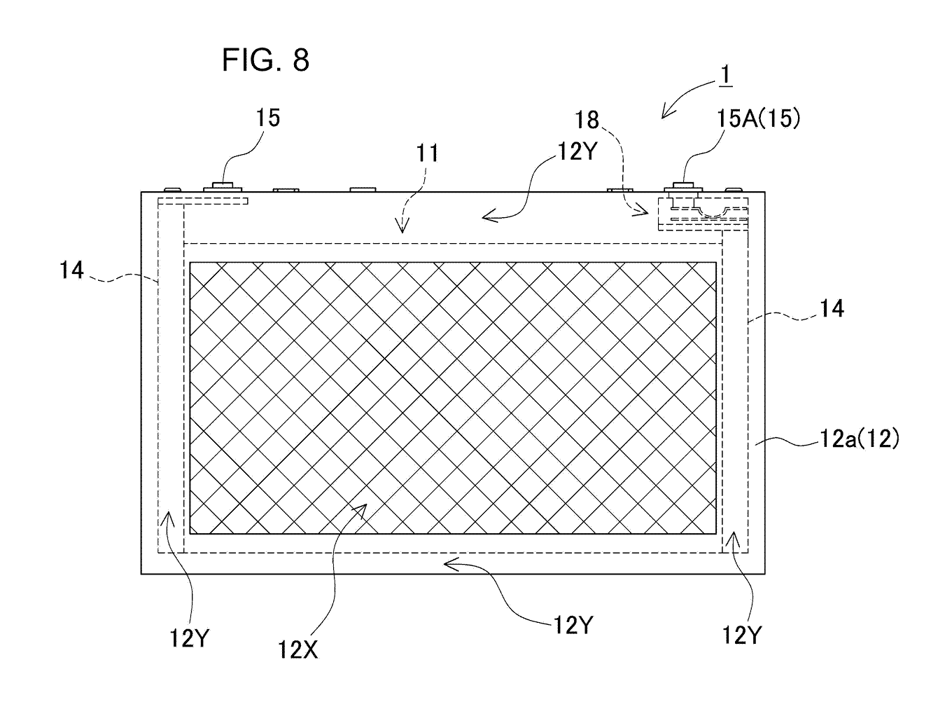

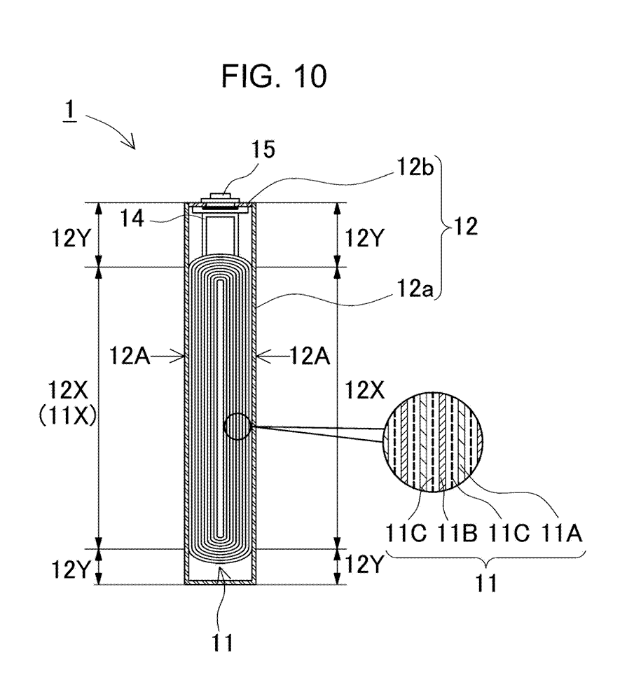

FIG. 8 to FIG. 10 show the flat secondary battery 1 of the lithium ion secondary battery. In the flat secondary battery 1 of these figures, the sealing plate 12b is weld-fixed to the opening portion of the outer can 12a, and the opening portion of the outer can 12a is airtightly sealed by the sealing plate 12b. The outer can 12a has a bottom portion closing a bottom, and a tubular shape of both facing surfaces being wide flat surfaces 12A, and the opening portion which opens upward in the figures. The outer can 12a of this shape is made by pressing a metal board, for example, such as, aluminum, aluminum alloy, or the like.

A positive or negative electrode terminal 15 is insulated from the sealing plate 12b, and is fixed at both end portions of the sealing plate 12a. The positive or negative electrode terminal 15 is connected to the positive or negative core 31 of the electrode assembly 11 which is disposed inside the outer can 12a through current collector 14. Further, the sealing plate 12b has a safety valve 34 which opens its valve when the internal pressure is increased up to a predetermined pressure. As the outer shape of the sealing plate 12b is approximately the same as the inner shape of the opening portion of the outer can 12a, the sealing plate 12b is inserted into the opening portion of the outer can 12a, and a laser beam is irradiated to a boundary between the sealing plate 12b and the outer can 12a, and the opening portion of the outer can 12a is airtightly sealed.

In the electrode assembly 11 of FIG. 4 to FIG. 6, the positive plate 11A and the negative plate 11B interposing separators therebetween are wound, and by this, the spiral electrode assembly 11U is made. Further, the spiral electrode assembly 11U is pressed from both sides by two of pressing plates 40, and the flat spiral electrode assembly in which facing surfaces are flat surface is made with a predetermined thickness. The pressing pressure by which the spiral electrode assembly 11U is pressed into the flat shape, is set, such that it is possible to insert the spiral electrode assembly 11U into the outer can 12a, and the injected electrolyte quickly infiltrates inside, and the electrode assembly 11 can be swollen. When the pressing pressure by which the spiral electrode assembly 11U is pressed, is too strong, the positive electrode plate 11A and the negative electrode plate 11B become in a tightly contacted or consolidated state of high density, and the injected electrolyte cannot quickly infiltrate, and the electrode assembly 11 cannot be swollen by the infiltrating electrolyte. But, when the pressing pressure is too weak, its thickness by which the spiral electrode assembly 11U can be smoothly inserted into the outer can 12a cannot be obtained by pressing. Therefore, the pressing pressure of the spiral electrode assembly 11U is set, such that it is possible that the electrode assembly 11 is swollen until the flat spiral electrode assembly 11 presses against the inner surface of the outer can 12a when the electrode assemblies 11 are swollen by the electrolyte injected into the outer can 12a, and also such that it is possible to insert the spiral electrode assembly 11U having the thickness by pressing into the outer can 12a, for example, less than 11 MPa, preferably less than 0.5 MPa.

The electrode assembly 11 of FIG. 4 has exposed core portions 31y which are not coated with positive electrode active material 32A or negative electrode active material 32B at one side portions. Except these one side portions, the cores 31 are coated with the positive electrode active material 32A or the negative electrode active material 32B. The core 31 is a metal foil having conductivity. The positive plate 11A and the negative plate 11B have the exposed core portions 31y at opposite side portions, and the areas which are coated with the positive electrode active material 32A or the negative electrode active material 32B are facing, and the positive plate 11A and the negative plate 11B are wound interposing the separators 11C therebetween in a spiral form. As shown in FIG. 5, the wound spiral electrode assembly 11U is pressed into the flat shape by the pressing plates 40 of the press machine.

As mentioned above, the electrode assembly 11 of the flat shape by pressed shaping has the exposed core areas 11Y at the opposite side portions, and an active material coating area 11X therebetween. In the exposed core areas 11Y at the opposite side portions in the electrode assembly, at one side, the core 31 of the positive electrode plate 11A is exposed, and at the other side, the core 31 of the negative electrode plate 11B is exposed. The exposed core portions 31y of the positive electrode plate 11A is stacked each other without the separator, and is connected to the current collector 14 of the positive electrode plate 11A. The exposed core portions 31y of the negative electrode plate 11B is stacked each other without the separator, and is connected to the current collector 14 of the negative electrode plate 11B. The current collector 14 of the positive electrode plate 11A and the current collector 14 of the negative electrode plate 11B are each connected by welding, etc., to the electrode terminals 15 of the positive electrode plate 11A or the negative electrode plate 11B which is fixed to the sealing plate 12b.

As mentioned above, the electrode assembly 11 of the flat shape by pressed shaping is stored in the outer can 12a in a posture that an winding axis m of the spiral form is disposed in parallel with the sealing plate 12b. The exposed core areas 11Y at the opposite side portions are disposed at both sides of the outer can 12a, namely at both sides of the wide flat surface 12A of the outer can 12a of the flat shape.

The electrode assembly 11 of the flat shape by pressed shaping is inserted in the outer can 12a, and the sealing plate 12a is disposed at the opening portion of the outer can 12a. The sealing plate 12b is coupled to the electrode assembly 11 through the current collectors 14. In this state, as the electrode assembly 11 is disposed in spaced relationship with the inner surface of the sealing plate 12b, a predetermined space is provided between the electrode assembly 11 and the sealing plate 12b. The sealing plate 12b which is disposed at the opening portion of the outer can 12a is welded by laser, etc., to the opening portion of the outer can 12a. After that, the electrolyte is injected through the injection hole 33 of the sealing plate 12b into the outer can 12a, and the injection hole 33 is airtightly closed.

In the above flat secondary battery, both sides and upper and lower portions of the wide flat surface 12A of the outer can 12a as an active material non-contact area 12Y do not contact the active material coating area 11X. An area except both sides and upper and lower portions of the wide flat surface 12A as an active material contact area 12X contacts the active material coating area 11X. Both sides of the wide flat surface 12A of the outer can 12a face the exposed core area 11Y, and become the active material non-contact area 12Y which does not contact the active material coating area 11X. In the upper portion of the wide flat surface 12A, there is no electrode assembly 11 at its inner surface, or the upper portion of the wide flat surface 12A does not contact the active material coating area 11X because there is a curved portion of the spiral form in the electrode assembly 11. The lower portion of the wide flat surface 12A does not contact the active material coating area 11X because there is a curved portion of the spiral form in the electrode assembly 11. The upper and lower portions of the wide flat surface 12A become the active material non-contact area 12Y.

As shown in FIG. 4, in the positive electrode plate 11A and the negative electrode plate 11B used in the electrode assembly 11, the cores 31 having a long narrow strip shape, are coated with the positive electrode active material 32A or the negative electrode active material 32B. Lithium transition-metal composite oxides that can reversibly adsorb and desorb lithium ions as the positive electrode active material 32A of the lithium ion secondary battery can be used. As the lithium transition-metal composite oxides that can reversibly adsorb and desorb lithium ions, for example, lithium cobalt oxide (LiCoO₂), lithium manganite (LiMnO₂), lithium nickel oxide (LiNiO₂), a lithium-nickel-manganese composite oxide (LiNi₁₋ₓMnₓO₂(0<x<1)), a lithium-nickel-cobalt composite oxide (LiNi₁₋ₓCoₓO₂(0<x<1)), a lithium-nickel-cobalt-manganese composite oxide (LiNiₓMn_{y}Co_{z}O₂(0<x<1, 0<y<1, 0<z<1, x+y+z=1)), or the like can be used. Further, material in which Al, Ti, Zr, Nb, B, Mg, or Mo is added to the above lithium transition-metal composite oxides can be used. For example, a lithium transition-metal composite oxide expressed by Li₁₊ₐNiₓCo_{y}Mn_{z}M_{b}O₂ (0≦a≦0.2, 0.2≦x≦0.5, 0.2≦y≦0.5, 0.2≦z≦0.4, 0≦b≦0.02, a+b+x+y+z=1, and M is at least one element selected from the group consisting of Al, Ti, Zr, Nb, B, Mg, and Mo) can be used. A filling density of the positive electrode plate 11A is preferably 2.5 to 2.9 g/cm³, more preferably 2.5 to 2.8 g/cm³. Here, the filling density of the positive electrode plate 11A means that the filling density of the positive electrode mixture layer containing the positive electrode active material 32A without the positive electrode core 31A.

The positive electrode plate 11A is preferably prepared in the following. Li₂CO₃ and (Ni_{0.35}Co_{0.35}Mn_{0.3})₃O₄ were mixed such that Li and (Ni_{0.35}Co_{0.35}Mn_{0.3}) were in the ratio of 1:1 by mol. Thereafter, this mixture was calcined at 900° C. for 20 hours in the atmosphere of the air, and a lithium transition-metal composite oxide expressed by LiNi_{0.35}Co_{0.35}Mn_{0.3}O₂ was obtained as the positive electrode active material 32A. The above positive electrode active material 32A, a flaky graphite and a carbon black as a conductive agent, and a powder of polyvinylidene fluoride (PVdF) as a binder were mixed in the ratio of 88:7:2:3 (=lithium transition-metal composite oxide:flaky graphite:carbon black:PVdF) by mass. The resultant mixture was dispersed in N-methyl-2-pyrrolidone (NMP) to make a positive electrode mixture slurry. This positive electrode mixture slurry was coated on one surface of a15 μm (=micrometer) thick positive electrode core 31A made of aluminum alloy foil, and by drying and eliminating NMP used as a solvent at the time of making the slurry, a positive electrode mixture layer containing the positive electrode active material was formed. In the same way, the positive electrode mixture layer containing the positive electrode active material was formed on the other surface of the aluminum alloy foil. After that, it was pressed with a roll press, and by cutting it into the predetermined size the positive electrode plate 11A was made.

As the negative electrode active material 32B of the lithium ion secondary battery, carbon material that can reversibly adsorb and desorb lithium ions can be used. As the carbon material that can reversibly adsorb and desorb lithium ions, graphite, non-graphitized carbon, easily graphitizable carbon, glassy carbon, coke, carbon black or the like can be used, but especially graphite is suitable.

The negative electrode plate 11B is preferably prepared in the following. The artificial graphite as the negative electrode active material 32B, carboxymethylcellulose (CMC) as a thickener, and styrene-butadiene rubber (SBR) as a binder were mixed in the ratio of 98:1:1 by mass, and the mixture was dispersed in water to make a negative electrode mixture slurry. This negative electrode mixture slurry was coated on one surface of a10 μm (=micrometer) thick negative electrode core 31B made of copper foil, and by drying and eliminating water used as a solvent at the time of making the slurry, a negative electrode mixture layer containing the negative electrode active material was formed. In the same way, the negative electrode mixture layer containing the negative electrode active material was formed on the other surface of the copper foil. After that, it was pressed with a roll press.

As the separator 11C, a thermoplasticity resin film of porous membrane can be used. Polyolefin material of porous membrane, for example, polypropylene (PP), polyethylene (PE), or the like is suitable for the separator 11. Further, three layer structure of polypropylene (PP) and polyethylene (PE) (PP/PE/PP, or PE/PP/PE) can be used as the separator 11C.

As non-aqueous solvent of non-aqueous electrolyte, kinds of carbonate, lactone, ether, ketone, ester or the like which are commonly used in a non-aqueous electrolyte secondary battery can be used, and equal to or more than two kinds of those non-aqueous solvent can be used in combination. Among these, kinds of carbonate, lactone, ether, ketone, ester or the like is preferable, and a kind of carbonate is more preferable.

For example, cyclic carbonates such as ethylene carbonate, propylene carbonate, butylene carbonate, or the like, and chain carbonates such as dimethyl carbonate, ethyl methyl carbonate, diethyl carbonate, or the like can be used. Especially It is desirable that cyclic carbonates and chain carbonates are mixed. Further, unsaturated cyclic ester of carbonic acid of vinylene carbonate (VC) or the like can be added to the non-aqueous electrolyte.

Lithium salts commonly used as the electrolyte salt in a non-aqueous electrolyte secondary battery can be used as electrolyte salts in the non-aqueous solvent. For example, LiPF₆, LiBF₄, LiCF₃SO₃, LiN (CF₃SO₂)₂, LiN (C₂F₅SO₂)₂, LiN (CF₃SO₂) (C₄F₉SO₂), LiC(CF₃SO₂)₃, LiC (C₂F₅SO₂),₃, LiAsF₆, LiClO₄, Li₂B₁₀Cl₁₀, Li₂B₁₂Cl₁₂, LiB (C₂O₄)_{2,}, LiB (C₂O₄) F_{2,}, LiP (C₂O₄)₃, LiP(C₂O₄)₂F_{2,}, LiP(C₂O₄) F₄, or the like and mixtures of them can be used. Among them, especially LiPF₆ is desirable. The amount of electrolyte salt dissolved in the non-aqueous solvent is preferably 0.5 to 2.0 mol/L.

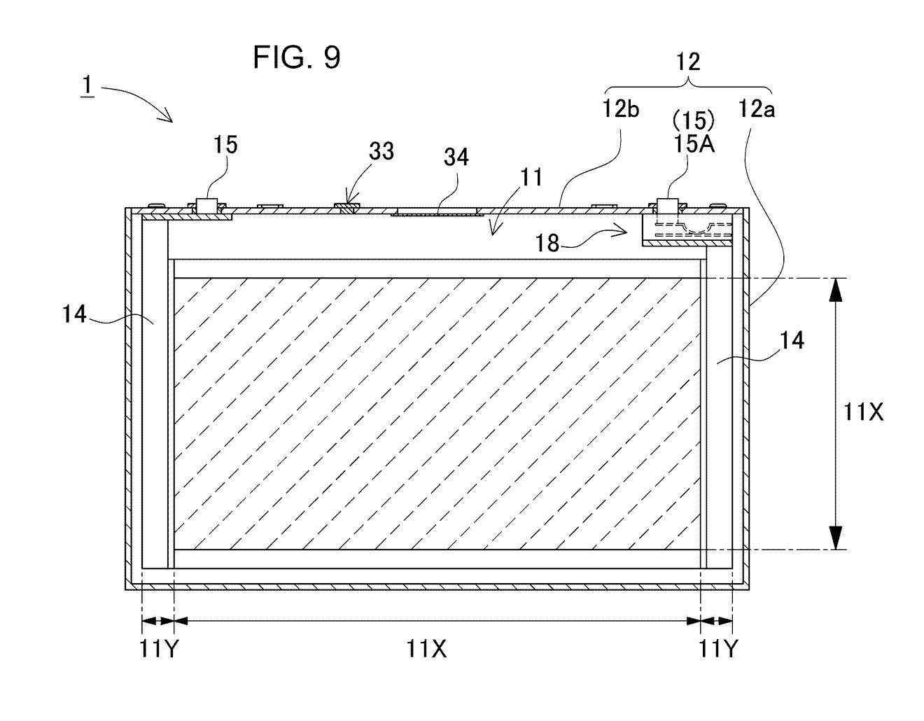

The flat secondary battery 1 shown in FIG. 9 incorporates a current interrupt device 18 which interrupts current at the time when an internal pressure in the outer can 12a increases up to a predetermined value. The current interrupt device 18 is ON when the battery internal pressure is equal to or less than the predetermined value, and the current interrupt device 18 is turned off when the battery internal pressure becomes more than the predetermined value, and then current is interrupted. In the flat secondary battery 1 shown in FIG. 9, the current interrupt device 18 is disposed inside the sealing plate 12b, and is connected between the positive electrode terminal 15A and the current collector 14. In the flat secondary battery 1 shown in FIG. 9, the safety valve 34 is provided in the sealing plate 12b. In order to prevent a damage of the outer can 12a at the time of an increase of the battery internal pressure, the safety valve 34 opens its valve and exhausts an inner gas or the electrolyte when the battery internal pressure is increased up to a predetermined pressure. The predetermined pressure at which the current interrupt device 18 interrupts current is set at lower value than the predetermined pressure at which the safety valve 24 opens. When the internal pressure is increased by charging and discharging in the abnormal state, in the flat secondary battery 1, first, the current interrupt device 18 is turned off and the current is interrupted, and after that, when the internal pressure is further increased, the safety valve 34 opens and the damage of the outer can 12a is prevented.

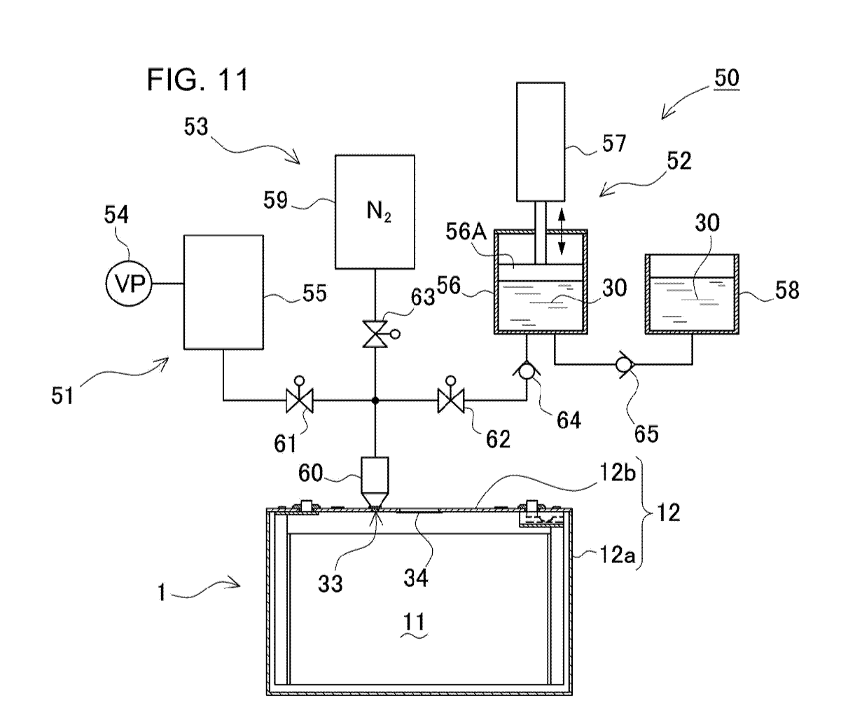

In the flat secondary battery 1, after inserting the electrode assembly 11 of the flat shape into the outer can 12a, the electrolyte 30 is injected. The electrolyte 30 is injected through the injection hole 33 of the sealing plate 12b which closes the opening portion of the outer can 12a. FIG. 11 shows one example of the electrolyte injection apparatus 50. In this electrolyte injection apparatus 50, the tip portion of a nozzle 60 is airtightly coupled to the injection hole 33 of the sealing plate 12b. In order that the injected electrolyte quickly infiltrates into the electrode assembly 11, after the internal pressure of the outer can 12a is reduced, namely the air inside the outer can 12a is exhausted, the electrolyte 30 is injected under the pressurized condition. Therefore, the electrolyte injection apparatus 50 has a pressure reducing structure 51 which reduces the pressure inside an outer case 12, and a pressurizing injection structure 52 which pressurizes and injects the electrolyte 30. Further, the electrolyte injection apparatus 50 of the figure has a gas filling structure 53 which fills nitrogen gas as inert gas inside the outer can 12a.

The pressure reducing structure 51 has a pressure reducing tank 55 in which a vacuum pump 54 reduces the pressure, and a decompression valve 61 which is connected between the pressure reducing tank 55 and the nozzle 60. This pressure reducing structure 51 opens the decompression valve 61 in a state that the nozzle 60 is coupled to the injection hole 33, and exhausts the air inside the outer can 12a.

The pressurizing injection structure 52 has a supplying cylinder 56 which pressurizes and injects the electrolyte 30, an injection valve 62 which is connected between the supplying cylinder 56 and the nozzle 60 through a check valve 64, a cylinder 57 as an actuator which reciprocates a piston 56A of the supplying cylinder 56, and a storage tank 58 of the electrolyte 30 which is coupled to the supplying cylinder 56 through a check valve 65. This pressurizing injection structure 52 opens the injection valve 62 in a state that the nozzle 60 is coupled to the injection hole 33, and pushes out the piston 56A of the supplying cylinder 56 by the cylinder 57 as the actuator, and then the electrolyte 30 is injected under the pressurized condition. The pressure which injects the electrolyte 30 under the pressurized condition is controlled by the pressure to the piston 56A of the supplying cylinder 56 by the cylinder 57 as the actuator.

The gas filling structure 53 has a gas tank 59 in which nitrogen gas is filled under the pressurized condition, a gas supplying valve 63 which is coupled between the gas tank 59 and the nozzle 60, and then by opening the gas supplying valve 63, nitrogen gas is injected inside the outer can 12a.

The above electrolyte injection apparatus 50 opens the decompression valve 61 and compulsorily exhausts the air inside the outer can 12a in the state that the nozzle 60 is coupled to the injection hole 33. In this state, the injection valve 62 of the pressurizing injection structure 52 and the gas supplying valve 63 of the gas filling structure 53 are held in a closed state. After reducing the pressure by exhausting the air inside the outer can 12a, the decompression valve 61 is closed, and the gas supplying valve 63 is held closed, and then the electrolyte 30 is injected under the pressurized condition by opening the injection valve 62. By a predetermined stroke movement of the cylinder 57 as the actuator, a fixed quantity of the electrolyte 30 is injected. After that, the cylinder 57 as the actuator is stopped, and the injection valve 62 is closed. In a state that the decompression valve 61 is closed, the gas supplying valve 63 is opened, and then nitrogen gas of inert gas is filled inside the outer can 12a. After that, the gas supplying valve 63 is closed, the injection valve 62 and the decompression valve 61 are hold closed, and the nozzle 60 is detached from the injection hole 33 of the sealing plate 12b. After that, the injection hole 33 of the sealing plate 12b is airtightly closed, and then the flat secondary battery 1 is completed.

The electrolyte 30 is also injected inside the outer can 12a by repeating the decompression and the pressurized injection plural times. In this way, after the pressure inside the outer can 12a is reduced, the fixed quantity of the electrolyte 30 is injected, and after that, by reducing the pressure inside the outer can 12a, the electrolyte 30 is injected. The way of repeating the decompression and the injection plural times enables that the electrolyte 30 more quickly infiltrates into the electrode assembly 11.

The above flat secondary battery 1 is manufactured in the following steps.

### (Winding Step)

The positive electrode plate 11A and the negative electrode plate 11B interposing separators 11C therebetween are wound into the spiral form, and then the spiral electrode assembly 11U shown in FIG. 5 and FIG. 6 is made.

### (Pressed Shaping Step)

As shown in FIG. 5 and FIG. 6, the spiral electrode assembly 11U obtained in the winding step is pressed into the electrode assembly of the flat shape by a predetermined pressure. Further, in this pressed shaping step, the spiral electrode assembly can also be pressed into the flat shape in a heated state.

### (Electrolyte Injection Step)

The electrode assembly 11 of the flat shape obtained in the pressed shaping step is inserted into the outer can 12a of the flat shape as shown in FIG. 7, and the opening portion of the outer can 12a is closed by the sealing plate 12b, and then the electrolyte 30 is injected through the injection hole 33 of the sealing plate 12b.

### (Sealing Step)

In a state that the electrolyte 30 is injected inside the outer can 12a and the electrode assembly 11 is swollen by the electrolyte 30, the injection hole 33 of the sealing plate 12b is airtightly closed.

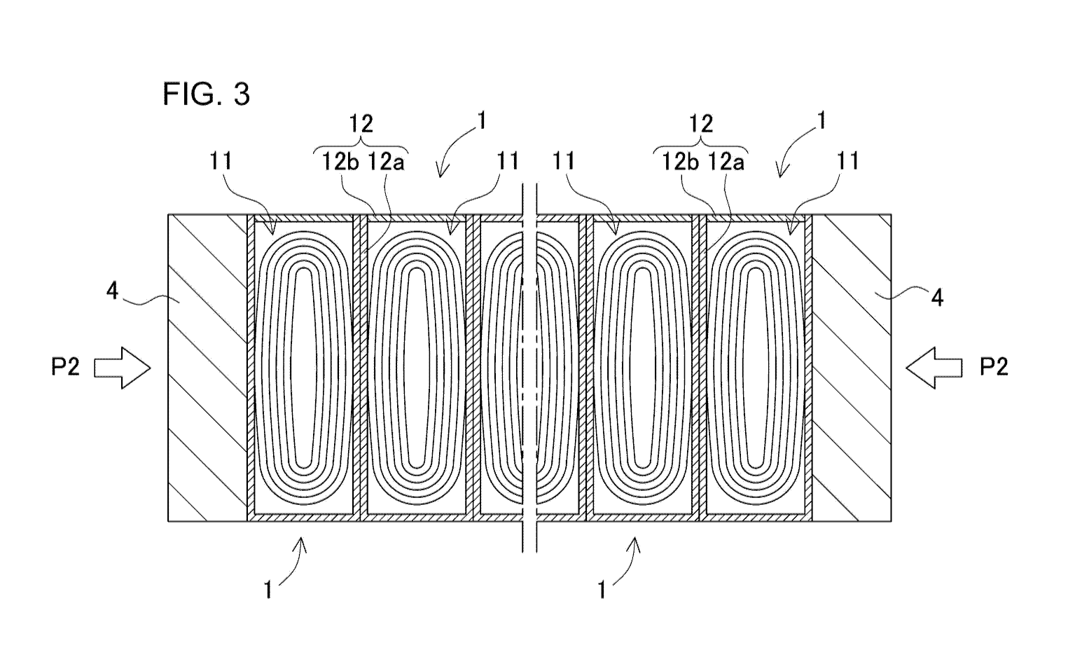

By using the flat secondary battery 1 manufactured in the above method, the battery stacked member 9 in which the flat secondary batteries 1 and the insulating members 2 are alternately stacked, is obtained. The end plates 4 are disposed at both ends of the battery staked member 9. As shown in the schematic sectional view of FIG. 3, the binding bars 4 are coupled to the end plates 5, and the battery staked member 9 is compressed from both end surfaces, and then each of the flat secondary batteries 1 is compressed and fixed in the pressed state in the stacked direction. The binding bars 5 are coupled to the end plates 4 at both end portions of the binding bars 5, and each of the flat secondary batteries 1 of the battery staked member 9 is compressed and fixed in the pressed state by a predetermined compressing pressure (P2).

The end plates 4 has the approximately same outer shape as the flat secondary battery 1, or the slightly bigger size than that of the flat secondary battery 1, and the end plates 4 are coupled to the binding bars 4 at the four corners of the end plates 4, and the end plates 4 are rectangular board shaped, and not deformed. The end plates 4 are coupled to the binding bars 4 at the four corners of the end plates 4, and in a state of surface contact with the flat secondary battery 1, surface contact portions are uniformly pressed by the predetermined compressing pressure (P2). The end plates 4 are positioned at both ends of the battery staked member 9, and the end plates 4 is pressed by a press machine, and then the flat secondary batteries 1 are compressed. Further, holding a state that the flat secondary batteries 1 are compressed in the stacked direction, the binding bars 5 are coupled to the four corners in this state, and then the flat secondary batteries 1 are compressed and fixed in the predetermined compressing pressure (P2). After the binding bars 5 coupling, the pressed state by the press machine is released.

The binding bars 5 are metal boards each having a L-shape in a lateral sectional view, and at both ends, the binding bars 5 have end edge plates 5A. The end edge plates 5A are coupled to L-shaped end surfaces of the binding bars 5, and contact the outer side surfaces of the end plates 4. The end edge plates 5A are disposed at the outer side surfaces of the end plates 4, and the binding bars 5 are coupled to the end plates 4. The end edge plates 5A of the binding bars 5 are coupled to the end plates 4, and by the end plates 4, the flat secondary batteries 1 are fixed in the compressed state. Further, the binding bars 4 are fixed to the outer surface of the end plates 4 by screw or the like. In the above battery pack 100, both ends of the binding bars 5 are coupled to a pair of the end plates 4, and the battery staked member 9 is sandwiched between the end plates 4, and each of the flat secondary batteries 1 are compressed by the predetermined compressing pressure (P2), and are fixed in the pressed state in the stacked direction. The compressing pressure (P2) of the flat secondary batteries 1 compresses the outer can 12a of the flat secondary batteries 1, and is set to the pressure by which the swollen electrode assemblies 11 are compressed.

The compressing pressure (P2) is a pressing force per unit area which is put on both surfaces of the flat secondary battery 1. Therefore, the compressing pressure (P2) is calculated by [the pressing force that the end plates 4 press the battery staked member 9 in the stacked direction]/[area of a flat portion of the flat secondary battery 1]. The compressing pressure (P2) is set at preferably more than pressing force (P1) of the spiral electrode assembly, for example, equal to or more than 1.2 times, preferably equal to or more than 1.5 times, more preferably equal to or more than 2 times. When the compressing pressure (P2) is too weak, the swell of the flat secondary battery 1 is not effectively suppressed or reduced. Conversely, when the compressing pressure (P2) is too strong, problem that the outer case 12 of the flat secondary battery 1 is damaged, occurs. Therefore, the compressing pressure (P2) is set at an optimum value in the above range, considering type or size of the flat secondary battery, further material, shape, wall thickness, size, swell property of the electrode assembly, or the like.

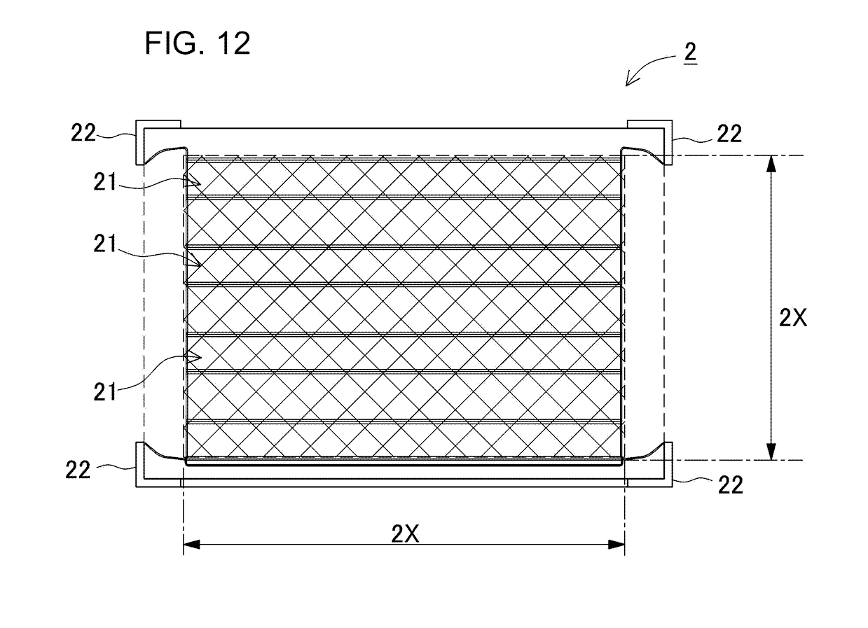

The insulating members 2 which are sandwiched and fixed between the flat secondary battery 1, are made by molding out of insulating plastic. The insulating members 2 shown in a plan view of FIG. 12, have the approximately same outer flat shape as the flat secondary battery 1, and at the four corner portions, guide walls 22 which dispose the flat secondary battery 1 inside at a fixed position, are provided. The guide walls 22 are L-shaped, and the corner portions are disposed inside the guide walls 22, and the flat secondary battery 1 is disposed at the fixed position.

The insulating members 2 uniformly compress the whole surfaces of the facing wide flat surfaces 12A of the outer cans 12a, or press a center portion of the wide flat surfaces more strongly than a peripheral portion, and compress the swollen electrode assembly 11. The insulating member 2 of FIG. 12 has a pressing portion 2X which presses the center portion of the wide flat surface 12A of the outer can 12a more strongly than the peripheral portion, at the center portion (shown in the figure by cross-hatching) except both side portions and upper or lower portion. This insulating member 2 strongly presses the center portion of the outer can 12a by the pressing portion 2X, and the swollen electrode assembly 11 is effectively compressed.

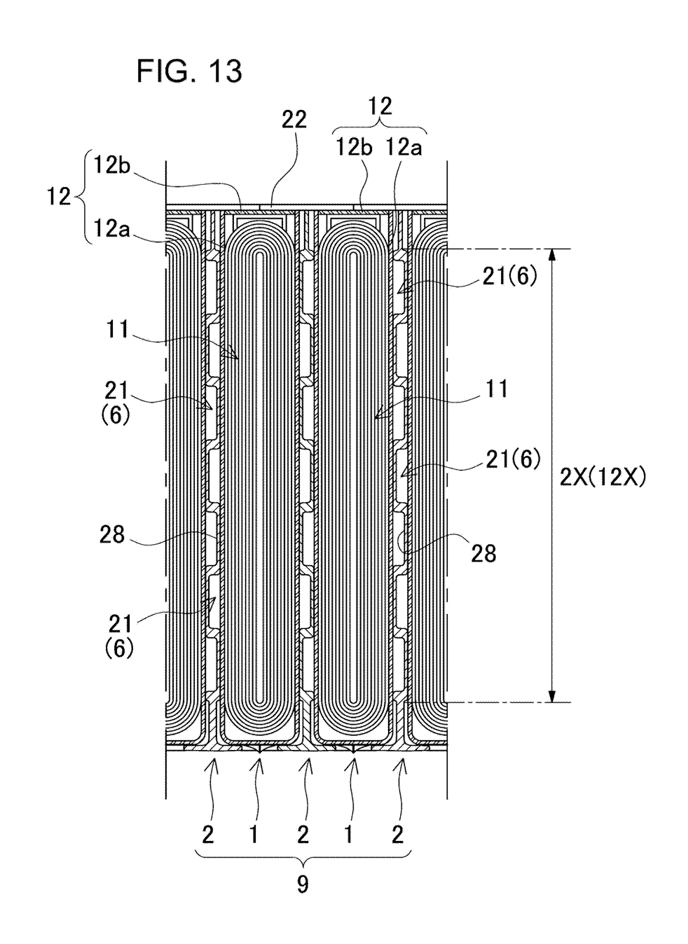

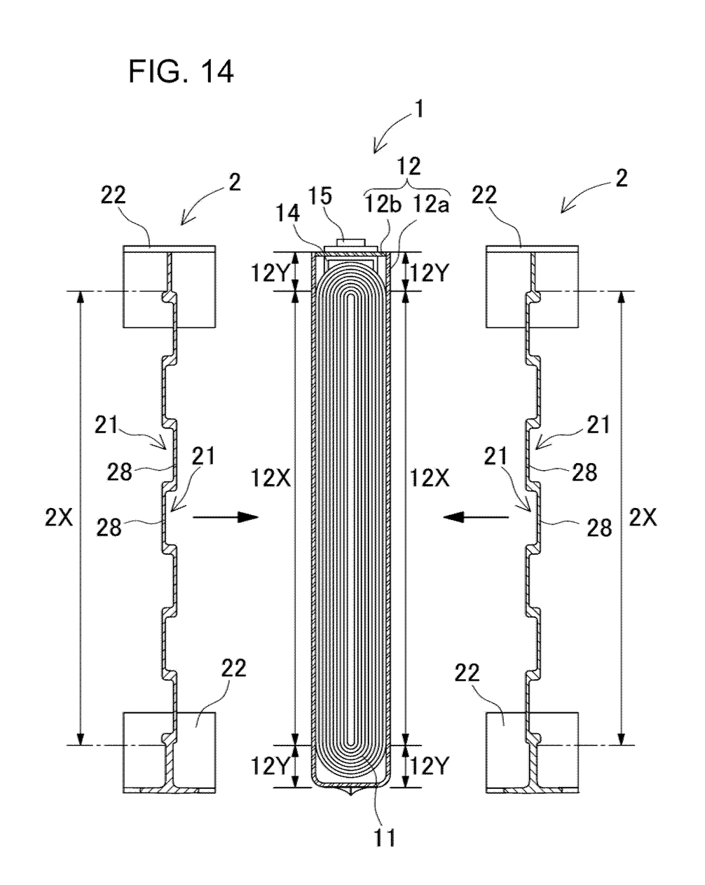

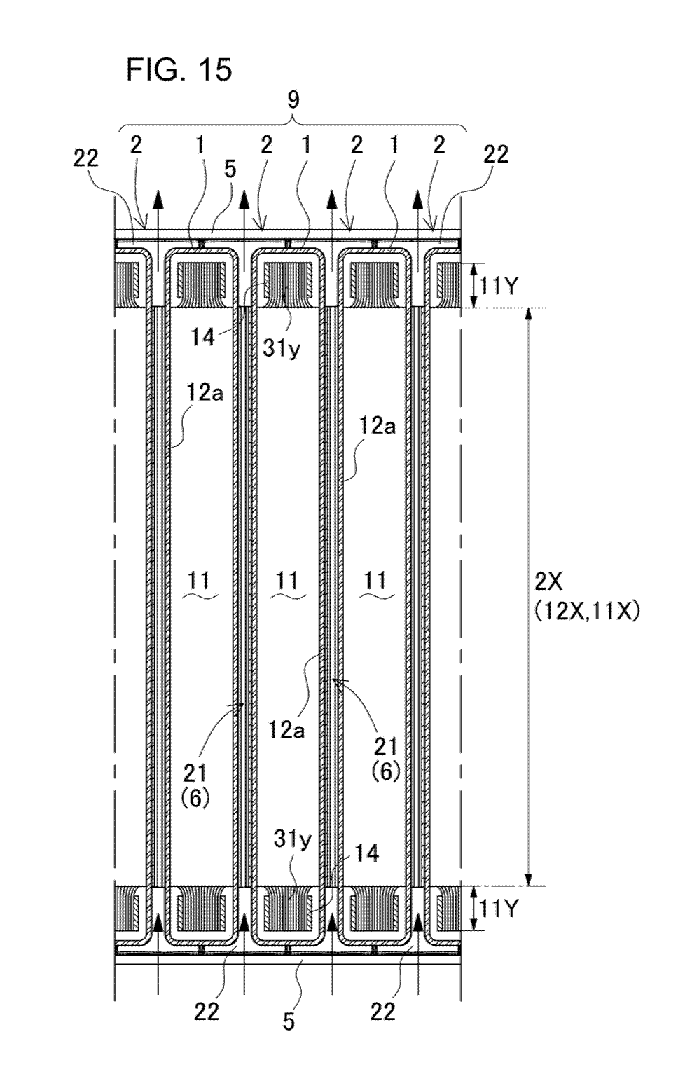

Further, the insulating members 2 shown in FIG. 13 to FIG. 15, have plural rows of cooling spaces between the flat secondary batteries 1 stacked on both surfaces thereof. The flat secondary batteries 1 can be forcibly cooled by forcibly blowing cooled air of cooling mechanism (not shown in the figures) to the cooling spaces 6 of the insulating members 2. Plural rows of cooling grooves 21 are provided alternately on both surfaces of the insulating members 2, and bottom boards 28 of the cooling grooves 21 tightly contact the outer can 12a of the opposite flat secondary battery 1, and press the wide flat surface 12A. In this insulating member 2, the flat secondary batteries 1 can be forcibly cooled by forcibly blowing cooled air to the cooling spaces 6 of the insulating members 2. But the insulating member does not necessarily need to have the cooling spaces, and also have a flat surface or a approximately flat surface as the pressing portion, and then can press the wide flat surface of the outer can.

The above battery pack is assembled in the following steps.

(1) The insulating members 2 are sandwiched between plural flat secondary batteries 1, and the battery stacked member 9 is obtained.
(2) The end plates 4 are positioned at both ends of the battery staked member 9, and the end plates 4 is pressed by the press machine, and the battery staked member 9 is pressed by the end plates 4 in the predetermined compressing pressure, and the flat secondary batteries 1 are compressed and held in the pressed state.

In this state, the insulating members 2 press the inner surfaces of the outer cans 12a, and the electrode assemblies 11 which are swollen by the electrolyte 30, are compressed by the insulating members 2 through the outer cans 12a.

(3) The battery staked member 9 is held in the pressed state, and the binding bars 5 are coupled to a pair of the end plates 4, and then the flat secondary batteries 1 are compressed and fixed in the pressed state.
(4) In the pressed state of the battery staked member 9, bus bars 13 are coupled to the electrode terminals 15 of the flat secondary batteries 1. The bus bars 13 connect the flat secondary batteries 1 in series, or in series and parallel. The bus bars 13 are welded and fixed to the electrode terminals 15, or are fixed by screw.

### INDUSTRIAL APPLICABILITY

A method for manufacturing a battery pack according to the present invention can be suitably used as the manufacturing method of battery packs of plug-in hybrid vehicles and hybrid electric vehicles that can switch between the EV drive mode and the HEV drive mode, electric vehicles, and the like. A vehicle including this power supply device according to the present invention can be suitably used as plug-in hybrid vehicles, hybrid electric vehicles, electric vehicles, and the like. Also, a power supply device according to the present invention can be suitably used as the manufacturing method of battery packs that can be installed on a rack of a computer server, backup power supply devices for wireless communication base stations, electric power storages for home use or plant use, electric power storage devices such as electric power storages for street lights connected to solar cells, backup power supplies for signal lights, and the like.

1. A method for manufacturing a battery pack comprising:
a winding step of winding into a spiral electrode assembly a positive electrode plate and a negative electrode plate interposing separators therebetween;
a pressed shaping step of pressing the spiral electrode assembly obtained in the winding step into an electrode assembly of a flat shape;
an electrolyte injection step of inserting the electrode assembly of the flat shape obtained in the pressed shaping step into an outer can of a flat shape, and injecting an electrolyte into the outer can;
a sealing step of airtightly sealing the outer can in which the electrolyte is injected; and
a compressing step of stacking a plurality of flat secondary batteries obtained in the sealing step as a battery staked member, compressing and fixing in a pressed state of the flat secondary batteries constituting the battery staked member by applying a predetermined pressure in the stacking direction of the battery staked member,
wherein in the pressed shaping step, a pressing pressure of pressing the spiral electrode assembly is set, such that it is possible to insert the pressed electrode assembly into the outer can, and such that it is possible that the electrode assembly is swollen until the electrode assembly presses against the inner surface of the outer can when the electrode assemblies are swollen by the electrolyte injected into the outer can in the electrolyte injection step,
wherein in the compressing step, the swollen electrode assemblies are pressed through the outer cans by pressing the outer cans of the flat secondary batteries.

2. The method for manufacturing the battery pack according to claim 1, wherein the pressing pressure in the pressed shaping step is lower than the pressure in the compressing step.

3. The method for manufacturing the battery pack according to claim 1,
wherein the flat secondary battery incorporates a current interrupt device which interrupts current by an increase of an internal pressure, and in the electrolyte injection step, the electrolyte is injected under a pressurized condition by a lower pressure than a working pressure of interrupting current in the current interrupt device.

4. The method for manufacturing the battery pack according to claim 1,
wherein in the electrolyte injection step, while the pressure of the outer can is reduced, the electrolyte is injected under the pressurized condition.

5. The method for manufacturing the battery pack according to claim 4,
wherein in the electrolyte injection step, the electrolyte is injected by repeating a step of reducing the pressure of the inside of the outer can, and a step of injecting the electrolyte under the pressurized condition.

6. The method for manufacturing the battery pack according to claim 1,
wherein in the step before the electrolyte injection step, a sealing plate having an injection hole is fixed to an opening portion of the outer can, and in the electrolyte injection step, the electrolyte is injected through the injection hole, and in the compressing step, the injection hole is airtightly sealed.

7. The method for manufacturing the battery pack to claim 1,
wherein in the compressing step, end plates are disposed at both ends of the battery staked member, and by binding bars being coupled to the end plates, the flat secondary batteries of the battery staked member are compressed and fixed in the pressed state.
